(19) United States
(12) Patent Application Publication
(10) Pub. No.: US 2013/0081096 A1
(43) Pub. Date: Mar. 28, 2013

(54) CABLE TELEVISION ENTRY ADAPTER

(71) Applicants: Chad Wells, Highlands Ranch, CO (US); John Egan, SR., Clearwater Beach, FL (US)

(72) Inventors: Chad Wells, Highlands Ranch, CO (US); John Egan, SR., Clearwater Beach, FL (US)

(73) Assignee: JOHN MEZZALINGUA ASSOCIATES, INC., East Syracuse, NY (US)

(21) Appl. No.: 13/245,510

(22) Filed: Sep. 26, 2011

(51) Int. Cl. H04N 21/60

(52) U.S. Cl. 725/120

(57) ABSTRACT

A cable television (CATV) entry adapter is disclosed which provides a means and method for transmitting upstream CATV requests to a CATV network without using an active upstream CATV signal path. The disclosed CATV entry adapter includes a transceiver that converts local-area network (LAN) signals to radio-frequency (RF) signals of an in-home entertainment (IHE) signal bandwidth, and vice versa. The LAN-to RF transceiver couples a LAN signal transmission path and an IHE signal transmission path within the entry adapter. The LAN-to RF transceiver converts IHE signals with encoded upstream CATV requests to LAN signals that include the upstream CATV requests. The LAN signals with upstream CATV requests can then be delivered to a cable modem for conversion into passive upstream CATV signals that include the encoded upstream CATV requests. The entry adapter can then deliver the passive upstream CATV signals with encoded upstream CATV requests to the CATV network.

### CROSS REFERENCE TO RELATED APPLICATION[S]

This application incorporates herein by reference the subject matter of the following co-pending U.S. patent applications which are assigned to the same assignee: Ser. No. 12/250,229, Filed Oct. 13, 2008 titled Ingress Noise Inhibiting Network Interface Device and Method for Cable Television Networks; Ser. No. 12/175,366, Filed Jul. 17, 2008 titled Passive-Active Terminal Adapter and Method Having Automatic Return Loss Control; Ser. No. 12/255,008, Filed Oct. 21, 2008 titled Multi-Port Adapter, Hub and Method for Interfacing a CATV Network and a MoCA Network; Ser. No. 12/563,719, Filed Sep. 21, 2009 titled Passive Multi-Port Entry Adapter and Method for Preserving Downstream CATV Signal Strength within In-Home Network; Ser. No. 12/704,833, Filed Feb. 12, 2010 titled CATV Entry Adapter and Method Utilizing Directional Couplers for MoCA Signal Communication; and Ser. No. 12/691,149, Filed Jan. 21, 2010 titled CATV Entry Adapter and Method for preventing Interference with eMTA Equipment from MoCA Signals.

### BACKGROUND OF THE INVENTION

1. Technical Field

This invention relates generally to cable television (CATV) entry adapters and in particular to an entry adapter which provides a means to transmit upstream CATV requests from CATV subscriber equipment to the CATV network without using an active upstream CATV signal.

2. State of the Art

Community access television, or cable television, (CATV) networks use an infrastructure of interconnected coaxial cables, splitters, amplifiers, filters, trunk lines, cable taps, drop lines and other signal-conducting devices to supply and distribute radio-frequency (RF) “downstream” CATV signals from a main signal distribution facility, known as a head-end, toward subscriber premises such as homes and businesses. The downstream signals operate the subscriber equipment, such as television sets, telephones, and computers. The typical CATV network is a two-way communication system. CATV networks also transmit RF “upstream” CATV signals from the subscriber equipment back to the head-end of the CATV network. Upstream CATV signals are encoded with upstream CATV requests, which are communications or requests from the subscriber to the CATV head-end. For example, upstream CATV requests may include data related to video-on-demand services, such as video requests and billing authorization. Upstream CATV requests are encoded onto upstream CATV signals that travel from the subscriber to the CATV network through the CATV entry adapter.

To permit simultaneous communication of upstream and downstream CATV signals and the interoperability of the subscriber equipment and the equipment associated with the CATV network infrastructure outside of subscriber premises, the downstream and upstream CATV signals are confined to two different radio-frequency (RF) bands. In most CATV networks the downstream frequency band, or downstream bandwidth, is within the range of 54-1002 megahertz (MHz) and the upstream frequency band, or upstream bandwidth, is within the range of 5-42 MHz.

Downstream CATV signals are delivered from the CATV network infrastructure to the subscriber premises at a CATV entry adapter, which is also commonly referred to as an entry device, terminal adapter or drop amplifier. The entry adapter is a multi-port device which connects at a premises entry port to a CATV drop cable from the CATV network infrastructure. The entry adapter connects at a multiplicity of other distribution ports to coaxial cables which extend throughout the subscriber premises to a cable outlet. Each cable outlet is available to be connected to subscriber equipment. Typically, most homes have coaxial cables extending to cable outlets in almost every room, because different types of subscriber equipment may be used in different rooms. For example, television sets, computers and telephone sets are commonly used in many different rooms of a home or office. The multiple distribution ports of the entry adapter deliver the downstream signals to each cable outlet and conduct the upstream signals from the subscriber equipment through the entry adapter to the drop cable and the CATV infrastructure.

Upstream CATV signals originate from the subscriber equipment and include upstream CATV requests for cable television services or other subscriber-generated signal content. Upstream CATV signals generated by subscriber equipment are gathered and bundled in the CATV entry adapter and sent to the CATV head-end via the CATV network.

The CATV entry adapter often divides the CATV signal transmission path within the entry adapter into an active CATV signal transmission path and a passive CATV signal transmission path. The passive CATV signal transmission path is often used to connect equipment which is required to function even if power is lost to the entry adapter. The passive CATV signal transmission path is used to connect lifeline telephones, for example. In the example of the lifeline telephone system, an embedded multimedia terminal adapter (eMTA) is connected to a passive signal port of the entry adapter. A telephone set is then connected to the eMTA device within the subscriber's house. This equipment is required to work in emergency situations and to be operable when the entry adapter loses power. The CATV passive signal transmission path within the entry adapter includes no powered circuit devices, and thus will still be operational when power is lost to the CATV entry adapter.

The active CATV signal transmission path is used to conduct CATV signals to and from non-emergency/critical multimedia equipment such as televisions, computers, and set-top boxes. The active CATV signal transmission path within the entry adapter includes active signal components such as amplifiers and other powered signal-conditioning circuits which improve the signal strength and quality of the active CATV signals. Amplifying the CATV signals allows them to be divided among a greater number of pieces of subscriber equipment. There is an issue, however, with the active upstream CATV signal path and the active upstream CATV signals. Active upstream CATV signals have a frequency range of 5-42 MHz. Many common types of household noise exist in this frequency range. The active upstream CATV signal path tends to pick up noise from motors, fans, and other noisy devices within and around a subscriber premise. The noise in the active upstream CATV signals from one subscriber premise can add to the noise from other subscriber premises' active upstream CATV signals to drown the upstream CATV signals in the CATV network. Thus there is a need for a CATV entry adapter which does not use an active CATV signal transmission path to send CATV upstream signals. There is a need for a CATV entry adapter which can send upstream CATV requests to the CATV head-end without using an active upstream signal path, regardless of which port of the entry adapter the originating equipment is connected to.

In addition, set-top boxes which transmit upstream CATV requests must have a modem included as a part of the set-top box hardware to encode the upstream CATV requests onto the RF upstream CATV signal. Including a cable modem in each set-top box increases the fixed cost of each set-top box. It is desirable to have a method of transmitting upstream CATV requests from a set-top box without the set-top box being required to include a modem.

### DISCLOSURE OF THE INVENTION

The present invention relates to cable television (CATV) entry adapters and in particular to an entry adapter which provides a means to transmit upstream CATV requests from CATV subscriber equipment to the CATV network without using an active upstream CATV signal. Disclosed is a CATV entry adapter that includes a local-area-network (LAN) signal transmission path, an in-home entertainment (IHE) signal transmission path, and a LAN-to-radio-frequency (RF) transceiver. The LAN-to-RF transceiver electrically couples the LAN signal transmission path to the IHE signal transmission path. In some embodiments the LAN-to-RF transceiver is an Ethernet-to-RF transceiver which converts RF signals into Ethernet signals, and vice versa. In some embodiments the LAN-to-RF transceiver converts LAN signals into RF in-home entertainment (IHE) signals having a frequency greater than or equal to 1125 MHz, and vice versa. In some embodiments the IHE signal transmission path conducts IHE signals between an active network port of the CATV entry adapter and the LAN-to-RF transceiver. In some embodiments the IHE signal transmission path conducts IHE signals between the LAN-to-RF transceiver and a passive network port of the entry adapter.

Disclosed is a CATV entry adapter that includes a CATV signal transmission path, where the CATV signal transmission path conducts downstream CATV signals of a first frequency range and upstream CATV signals of a second frequency range between an entry port and at least one of a plurality of network ports. The entry adapter according to the invention also includes a local-area-network (LAN) signal transmission path, where the LAN signal transmission path conducts signals between a LAN port and a LAN-to-RF transceiver. The entry adapter also includes an in-home entertainment (IHE) signal transmission path, where the IHE signal transmission path conducts IHE signals of a third frequency range between the LAN-to-RF transceiver and at least one of the plurality of network ports.

In some embodiments the CATV signal transmission path includes a combined passive/active CATV signal transmission path, where the combined passive/active CATV signal transmission path conducts passive CATV signals and active CATV signals between the entry port and a splitter/combiner node of a first signal splitter. In some embodiments the CATV signal transmission path includes a passive CATV signal transmission path, where the passive CATV signal transmission path conducts passive CATV signals between a first splitter leg node of the first signal splitter and a passive network port. In some embodiments the CATV signal transmission path also includes an active CATV signal transmission path, where the active CATV signal transmission path conducts active CATV signals between a second splitter leg node of the first signal splitter and a low frequency node of a first diplexer. In some embodiments the CATV signal transmission path includes a combined active CATV/IHE signal transmission path, where the combined active CATV/IHE signal transmission path conducts active CATV signals and IHE signals between a splitter/combiner node of the first diplexer and one or more than one active network port. In some embodiments the IHE signal transmission path conducts signals between an RF signal node of the LAN-to-RF transceiver and a high-frequency node of the first diplexer.

In some embodiments the disclosed entry adapter includes a second signal splitter, where the second signal splitter couples the combined active/IHE signal transmission path to a plurality of network ports. In some embodiments the IHE signal transmission path includes a third signal splitter, where a splitter/combiner node of the third signal splitter is coupled to the IHE signal node of the LAN-to-RF transceiver, and where the third signal splitter divides the IHE signal transmission path into an IHE signal transmission path first leg and an IHE signal transmission path second leg. In some embodiments the IHE signal transmission path first leg conducts signals between a first splitter leg node of the third signal splitter and the high frequency node of the first diplexer. In some embodiments the entry adapter includes a second diplexer, where the second diplexer electrically couples both the passive CATV signal transmission path and the IHE signal transmission path second leg to the passive network port. In some embodiments the IHE signal transmission path second leg conducts signals between a second splitter leg node of the third signal splitter and the passive network port.

Disclosed is a method of conducting an upstream CATV request to a CATV network that includes the steps of receiving an upstream CATV request, where the upstream CATV request is encoded onto an in-home entertainment (IHE) signal, and converting the IHE signal into a local-area-network (LAN) signal, where the upstream CATV request is encoded onto the LAN signal. The method of transmitting an upstream CATV request to a CATV network also includes the steps of converting the LAN signal into an upstream CATV signal, where the upstream CATV request is encoded onto the upstream CATV signal and conducting the upstream CATV signal to a CATV network. In some embodiments the step of receiving an upstream CATV request encoded onto an IHE signal comprises the step of combining a plurality of IHE signals from a plurality of active network ports of an entry adapter into an IHE signal, where the upstream CATV request is encoded onto the IHE signal. In some embodiments the step of receiving an upstream CATV request encoded onto an IHE signal comprises the step of receiving the IHE signal encoded with the upstream CATV request at an IHE signal node of a LAN-to-RF transceiver, where the entry adapter comprises the LAN-to-RF transceiver. In some embodiments converting the IHE signal into a LAN signal includes converting the IHE signal into a LAN signal using a LAN-to-RF transceiver, where the upstream CATV request is encoded onto the LAN signal. In some embodiments the method of conducting an upstream CATV request to a CATV network also includes the step of conducting the LAN signal to a cable modem, where the cable modem is comprised in an embedded multimedia terminal adapter coupled to a passive port of an entry adapter. In some embodiments the step of converting the LAN signals into an upstream CATV signal is performed by an embedded multimedia terminal adapter coupled to a passive port of an entry adapter. In some embodiments the step of conducting the upstream CATV signal to a CATV network comprises the steps of conducting the upstream CATV signal to a passive port of an entry adapter, conducting the upstream CATV signal from the passive port of the entry adapter to an entry port of the entry adapter, and conducting the upstream CATV signal through the entry port of the entry adapter to the CATV network, where the upstream CATV request is encoded onto the upstream CATV signal.

The foregoing and other features and advantages of the present invention will be apparent from the following more detailed description of the particular embodiments of the invention, as illustrated in the accompanying drawings.

### BRIEF DESCRIPTION OF THE DRAWINGS

FIG. 1 is a block diagram of an embodiment of a CATV network 20 and two subscriber networks 12 which include embodiments of CATV entry adapter 10 according to the invention.

FIG. 2 is a block diagram of an embodiment of a CATV entry adapter 10 according to the invention, showing example connections between entry adapter 10, CATV network 20, subscriber network 12 and IHE entertainment network 14.

FIG. 3 shows a block diagram of one embodiment of CATV entry adapter 10 according to the invention.

FIG. 4 is a schematic diagram of an embodiment of splitter 76 of entry adapter 10 of FIG. 3.

FIG. 5 is a schematic diagram of an embodiment of diplexer 122 of entry adapter 10 of FIG. 3.

FIG. 6 is a schematic diagram of an embodiment of active circuitry 120 of entry adapter 10 of FIG. 3.

FIG. 7 shows a block diagram of an embodiment of CATV entry adapter 10 according to the invention.

FIG. 8 is a schematic diagram of an embodiment of splitter 162 of entry adapter 10 of FIG. 7.

FIG. 9 is a schematic diagram of an embodiment of diplexer 170 of entry adapter 10 of FIG. 7.

FIG. 10 shows method 400 according to the invention of conducting an upstream CATV request to a CATV network.

### DETAILED DESCRIPTION OF EMBODIMENTS OF THE INVENTION

As discussed above, embodiments of the disclosed invention relate to cable television (CATV) entry adapters and in particular to an entry adapter which provides a means to transmit upstream CATV requests without using an active upstream CATV signal path or active upstream CATV signals. Disclosed is a CATV entry adapter that includes a transceiver that converts local-area network (LAN) signals to radio-frequency (RF) signals and vice versa. The ability of the CATV entry adapter to convert back and forth between LAN signals and RF signals provides the entry adapter a means to transmit upstream CATV requests to a CATV head-end without using an active upstream CATV signal path within the entry adapter. The entry adapter as disclosed includes a LAN-to-RF transceiver, which couples a LAN signal transmission path and an in-home entertainment (IHE) signal transmission path within the entry adapter. The IHE signal transmission path conducts RF IHE signals between active ports of the entry adapter and the LAN-to-RF transceiver. The IHE signals can be encoded with upstream CATV requests. The LAN-to RF transceiver converts the IHE signals that are encoded with upstream CATV requests to LAN signals that include the upstream CATV requests. The LAN signals encoded with upstream CATV requests can then be delivered to a cable modem, such as the cable modem in an embedded multimedia terminal adapter (eMTA) device, which can convert the LAN signals encoded with upstream CATV requests into passive upstream CATV signals for delivery to the CATV network and eventually to the CATV head-end. In this way CATV upstream requests from a subscriber are delivered to the CATV head-end without using an active CATV signal path within the entry adapter, and without requiring a set-top box to include a cable modem. Details of the disclosed CATV entry adapter are described below.

Community access television, or cable television, (CATV) networks use an infrastructure of interconnected coaxial cables, splitters, amplifiers, filters, trunk lines, cable taps, drop lines and other signal-conducting devices to supply and distribute radio-frequency (RF) “downstream” CATV signals from a main signal distribution facility, known as a head-end, toward subscriber premises such as homes and businesses. The downstream signals operate the subscriber equipment, such as television sets, telephones, and computers. Downstream CATV signals contain the television, video, and multimedia data that is to be delivered to the subscriber.

The typical CATV network is a two-way communication system. CATV networks also transmit RF “upstream” CATV signals from the subscriber equipment back to the head-end of the CATV network. Upstream CATV signals are encoded with upstream CATV requests, which are communications or requests from the subscriber to the CATV head-end. Upstream CATV requests may include data related to video-on-demand services, such as video requests and billing authorization. Upstream CATV requests are encoded onto upstream CATV signals that travel from the subscriber to the CATV network through the CATV entry adapter. Upstream CATV signals and upstream CATV requests are also utilized when using a personal computer connected through the CATV infrastructure to the public Internet when sharing photo albums or entering user account information, for example. In yet another example, voice-over-internet protocol (VOIP) telephones and security monitoring equipment use the CATV infrastructure and the public internet as the communication medium for transmitting two-way telephone conversations and monitoring functions.

To permit simultaneous communication of upstream and downstream CATV signals and the interoperability of the subscriber equipment and the equipment associated with the CATV network infrastructure outside of subscriber premises, the downstream and upstream CATV signals are confined to two different radio-frequency (RF) bands. In most CATV networks the downstream frequency band, or downstream bandwidth, is within the range of 54-1002 megahertz (MHz) and the upstream frequency band, or upstream bandwidth, is within the range of 5-42 MHz.

Downstream CATV signals are delivered from the CATV network infrastructure to the subscriber premises at a CATV entry adapter, which is also commonly referred to as an entry device, terminal adapter or drop amplifier. The entry adapter is a multi-port device which connects at an entry port of the entry adapter to a CATV drop cable from the CATV network infrastructure. The entry adapter connects at a multiplicity of other distribution ports (network ports) to coaxial cables which extend throughout the subscriber premises to a cable outlet. Each cable outlet is available to be connected to subscriber equipment. Typically, most homes have coaxial cables extending to cable outlets in almost every room, because different types of subscriber equipment may be used in different rooms. For example, television sets, computers and telephone sets are commonly used in many different rooms of a home or office. The multiple distribution ports of the entry adapter deliver the CATV downstream signals to each cable outlet and the connected subscriber equipment.

Upstream CATV signals originate from the subscriber equipment and include upstream CATV requests for cable television services or other subscriber-generated signal content. Upstream CATV signals generated by subscriber equipment are gathered from the subscriber equipment, bundled in the CATV entry adapter, and sent to the CATV head-end via the CATV network.

The CATV entry adapter often divides the CATV signal transmission path within the entry adapter into an active CATV signal transmission path and a passive CATV signal transmission path. The passive CATV signal transmission path within the entry adapter is connected to a passive network port of the entry adapter. The passive CATV signal transmission path is often used to connect equipment which is required to function even if power is lost to the entry adapter. The CATV passive signal transmission path within the entry adapter includes no powered circuit devices, and thus will still be operational when power is lost to the CATV entry adapter. The passive CATV signal transmission path is used to connect critical equipment such as a lifeline telephone to the CATV network. In the example of the lifeline telephone system, an embedded multimedia terminal adapter (eMTA) is connected to a passive signal port of the entry adapter. An eMTA device is a combination of a cable modem and a VOIP adapter. A telephone set is connected to the eMTA device within the subscriber's house. The combination of the telephone set and the eMTA device allows the telephone to send and receive voice data over the CATV infrastructure. When the telephone set connected to the eMTA is a telephone set capable of sending and receiving emergency communications, such as requests for medical assistance or security breach information, the telephone is called a “lifeline telephone”, and is required to work in emergency situations and to be operable even when the entry adapter loses power. The CATV passive signal transmission path within the entry adapter provides this capability.

The active CATV signal transmission path is used to conduct CATV signals to and from non-emergency/critical multimedia equipment such as televisions, computers, and set-top boxes. The active CATV signal transmission path within the entry adapter is connected to one or more active network ports of the entry adapter. Active subscriber equipment is connected to the active network ports. The active subscriber equipment sends and receives CATV signals through the active network ports. The active CATV signal transmission path within the entry adapter includes active signal components such as amplifiers and other powered signal conditioning circuits which improve the quality of the active CATV signals. The use of signal amplifiers in the active CATV signal transmission path allows the active CATV signals to be divided into multiple copies and delivered to multiple active network ports. Without the use of amplifiers and/or other active circuitry in the active CATV signal transmission path, dividing the CATV signal among multiple destinations would lower the signal power and signal quality of the signal received by the subscriber equipment. This would degrade the quality of service as perceived by the subscriber. Thus the quality of service as perceived by the subscriber is higher when receiving active CATV signals that have been amplified and conditioned by the active components included in the active CATV signal transmission path within the entry adapter.

There is an issue, however, with the active upstream CATV signal path and the active upstream CATV signals. Upstream CATV signals have a frequency range of 5-42 MHz. Many common types of household noise exist in this frequency range. Active upstream CATV signals tend to pick up noise from motors, fans, and other noisy devices within and around a subscriber premise. This noise is then amplified by the active components in the active CATV signal path. The noise in the active upstream CATV signals from one subscriber premise can add to the noise from other subscriber premises' active upstream CATV signals to drown the upstream CATV signals in a CATV network. Thus the disclosed CATV entry adapter has been developed, which does not use an active upstream CATV signal transmission path to send upstream CATV signals or upstream CATV requests. The disclosed CATV entry adapter according to the invention uses an in-home entertainment (IHE) signal transmission path and a LAN-to-RF transceiver to deliver upstream CATV requests to the CATV network without using an active CATV signal transmission path or active CATV signals.

In addition to television sets, computers and telephones, a relatively large number of other entertainment and multimedia devices are available for use in homes and subscriber premises. For example, a digital video recorder (DVR) is used to record broadcast programming, still photography and moving pictures in a memory medium so that the content can be replayed on a display or television set at a later time selected by the user. As another example, computer games are also played at displays or on television sets. Such computer games may be those obtained over the internet from the CATV network or from media played on play-back devices connected to displays or television sets. In another example, receivers of satellite-broadcast signals may be distributed for viewing or listening throughout the home. These types of devices, including the more-conventional television sets, telephone sets and devices connected to the internet by the CATV network, are generically referred to as multimedia devices.

An in-home entertainment (IHE) network is often coupled to the CATV network via the same coaxial cables delivering the downstream and upstream bandwidth of the CATV system. An in-home entertainment network is a network for providing multiple streams of high-definition video and gaming entertainment for distribution within the subscriber premises. Examples of in-home entertainment network technologies include Ethernet, HomePlug, Home Phoneline Networking Alliance (HPNA), Multimedia over Coax Alliance (MoCA) and 802.11n protocols. The in-home entertainment (IHE) network is coupled to the CATV network within a subscriber premises to allow the CATV network to distribute ME signals from one multimedia device to another within the subscriber premises.

Since the operation of the subscriber premises IHE network must occur simultaneously with the operation of the CATV services, the IHE signals often utilize a frequency range different from the frequency ranges of the CATV upstream and downstream signals. A typical IHE frequency band is 1125-1675 MHz. A specific IHE network technology can include other frequency ranges, but the 1125-1675 MHz frequency range is of major relevance because of its principal use in establishing connections between the multimedia devices within a subscriber network.

Active subscriber equipment that has the ability to generate IHE signals can be used to encode upstream CATV requests onto the RF IHE signals. The upstream CATV requests would normally be sent via the upstream CATV signal transmission path on active upstream CATV signals in the 5-42 MHz frequency range. But since the active upstream 5-42 MHz frequency range is noisy, and we desire to avoid using active upstream CATV signals, it is possible to have the active subscriber equipment encode upstream CATV requests onto IHE signals that are within the IHE signal frequency band of 1125-1675 MHz. This frequency range is less likely to pick up noise from inside the subscriber premises. The disclosed entry adapter converts the IHE signals encoded with upstream CATV requests into local-area-network signals, which can then be sent to a modem for conversion to passive upstream CATV signals and sent to the head-end via the passive upstream CATV signal transmission path. In this way upstream CATV requests that originate from active subscriber equipment are delivered to the CATV head-end without using an active upstream CATV signal transmission path or active upstream CATV signals. In addition, where the active subscriber equipment originating the upstream CATV request is a set-top box, the set-top box is no longer required to include a modem for encoding the CATV requests onto active upstream CATV signals in the 5-42 MHz frequency range. Instead, the set-top box uses its IHE network capability to encode the upstream requests onto IHE signals in the 1125-1675 MHz frequency range.

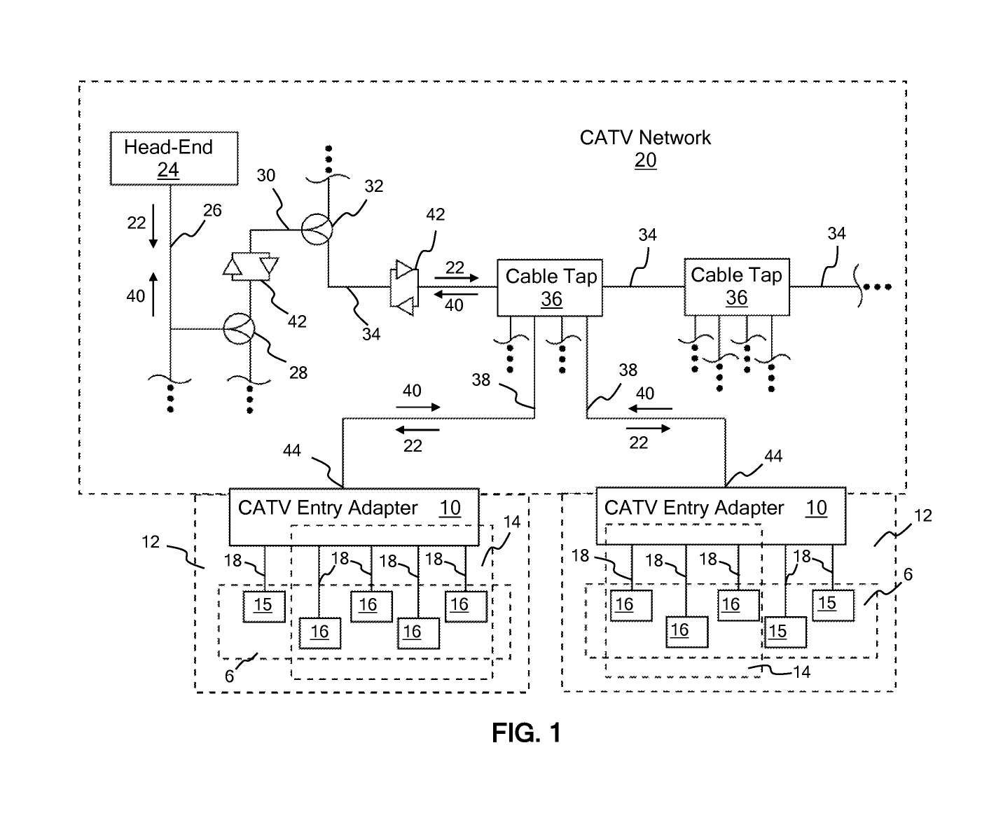

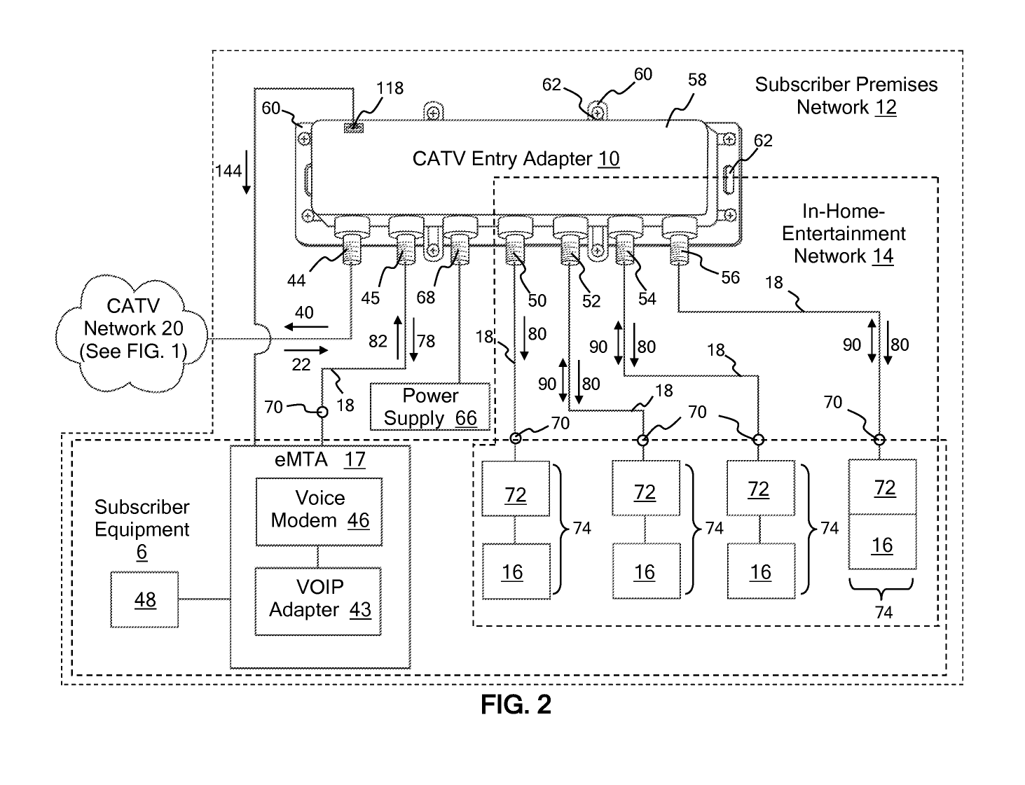

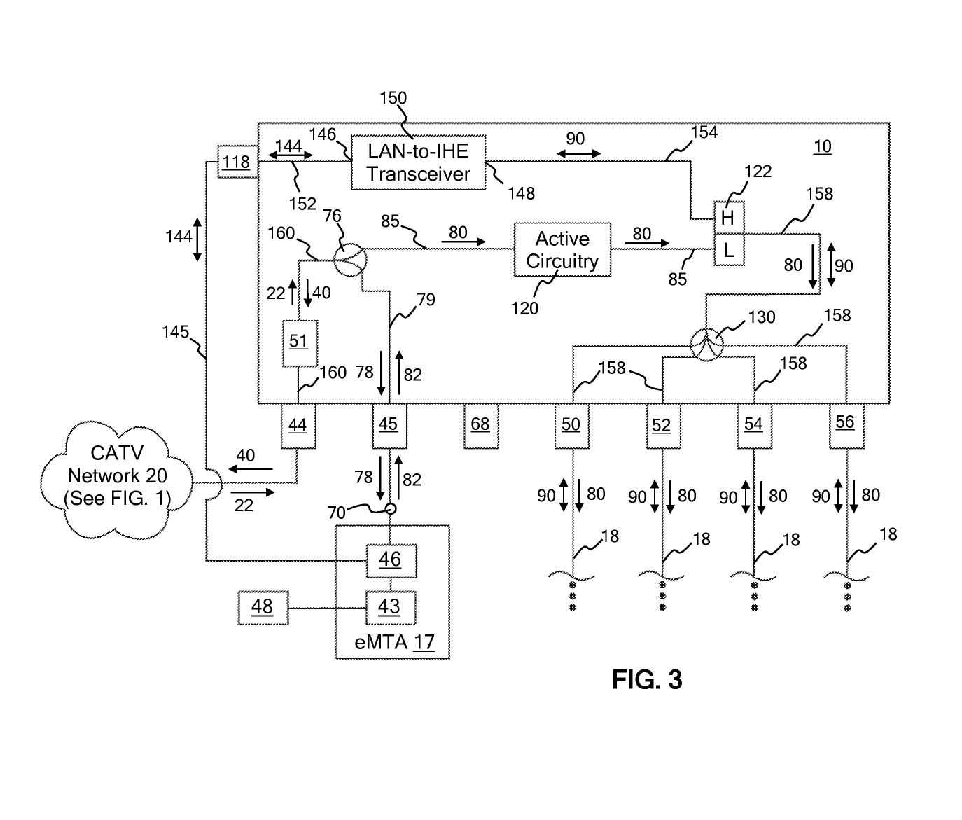

FIG. 1 shows a block diagram of an embodiment of a CATV network 20 and embodiments of subscriber networks 12 linked by CATV entry adapter 10 according to the invention. CATV entry adapter 10 is located at the subscriber premises. CATV entry adapter 10 (also referred to as entry adapter 10) is the interface between a subscriber premise network 12 and CATV network 20. CATV entry adapter 10 delivers CATV content or signals from CATV network 20 to subscriber equipment 6 within subscriber premises 12. CATV entry adapter 10 also forms a part of a conventional in-home entertainment (IHE) network 14. Subscriber equipment 6 receives signals from CATV network 20 via entry adapter 10 and coaxial cables 18. Subscriber equipment 6 includes all of the equipment in a subscriber premise that is coupled to entry adapter 10. Subscriber equipment 6 includes multimedia devices 15 which are not IHE signal-compatible and multimedia devices 16 which are IHE signal-compatible. Multimedia devices 15 are connected to entry adapter 10 and form a part of subscriber premise network 12, which distributes CATV signals within a subscriber premises. Examples of subscriber equipment 6 which may not be a part of in-home entertainment network 14 are voice modems and connected telephone sets, or any multimedia device which is not designed to send or receive signals using an IHE signal bandwidth or protocol.

Multimedia devices 16 are connected to entry adapter 10 and form a part of IHE network 14. Multimedia devices 16 can often communicate using both CATV signals and IHE signals. Multimedia devices 16 conduct IHE signals between one another using IHE network 14, which is formed in part by the preexisting coaxial cable infrastructure (represented generally by coaxial cables 18) present in the subscriber premises network 12. Examples of multimedia devices 16 are digital video recorders, computers, data modems, computer game playing devices, television sets, television set-top boxes, and other audio and visual entertainment devices. Multimedia devices 16 are designed to communicate using an IHE signal communication protocol, or they are equipped with an IHE interface device which provides them with this capability.

CATV entry adapter 10 has beneficial characteristics which allow it to function in multiple roles simultaneously in IHE network 14, subscriber network 12, and in CATV network 20, thereby benefiting all three networks. CATV entry adapter 10 functions as a hub of IHE network 14, to effectively transfer IHE signals between multimedia devices 16, including those that might be connected to passive ports of CATV entry adapter 10, as will be described in greater detail below. CATV entry adapter 10 also functions in a conventional role as an interface between CATV network 20 and subscriber equipment 15 located at the subscriber premises, thereby facilitating CATV service to the subscriber. In addition, CATV entry adapter 10 securely and privately confines IHE network communications within each subscriber premise and prevents IHE signals from entering CATV network 20 and degrading the strength of CATV signals conducted by CATV network 20. CATV entry adapter 10 according to the invention provides the means to send CATV upstream requests to CATV head-end 24 without using an active CATV signal transmission path within entry adapter 10. This eliminates the noisy active upstream CATV signal path within entry adapter 10 and eliminates noisy active upstream CATV signals from entering CATV network 20. These and other improvements and functions are described in greater detail below.

CATV network 20 shown in FIG. 1 has a typical topology. Downstream CATV signals 22 originate from programming sources at head-end 24 of CATV network 20, and are conducted to CATV entry adapter 10 in a sequential path through main trunk cable 26, signal splitter 28, secondary trunk cables 30, another signal splitter 32, distribution cable branches 34, cable taps 36, and drop cables 38. Upstream CATV signals 40 are delivered from CATV entry adapter 10 to CATV network 20, and are conducted to head-end 24 in a reverse sequential path. Interspersed at appropriate locations within the topology of CATV network 20 are conventional repeater amplifiers 42, which amplify both downstream CATV signals 22 and upstream CATV signals 40. Conventional repeater amplifiers may also be included in cable taps 36. Cable taps 36 and signal splitters 28 and 32 divide a single downstream CATV signal into multiple separate downstream signals, and combine multiple upstream CATV signals into a single upstream signal.

Referring now to FIG. 1 and to FIG. 2, CATV entry adapter 10 receives downstream CATV signals 22 from CATV network 20 entry port 44. Downstream CATV signals 22 are of a first frequency range, this first frequency range being 54-1002 MHz in this embodiment. Entry adapter 10 divides downstream CATV signals 22 into downstream passive CATV signals 78 and downstream active CATV signals 80. Downstream passive CATV signals 78 are those downstream CATV signals which are conducted through CATV entry adapter 10 without amplification, enhancement, modification or other substantial conditioning. Downstream passive CATV signals 78 are delivered from passive port 45 to passive subscriber equipment 6 located in subscriber network 12, such as eMTA 17 connected to telephone set 48 as shown in FIG. 2.

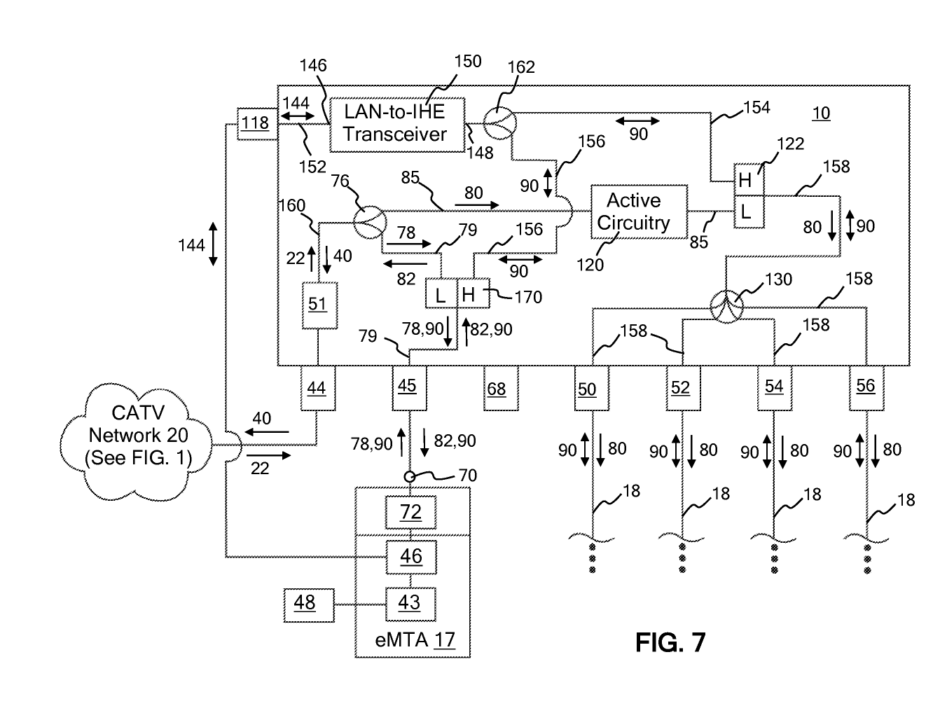

Downstream active CATV signals 80 are those downstream CATV signals which are amplified, filtered, modified, enhanced or otherwise conditioned by power-consuming active electronic circuit components within the CATV entry adapter 10. The conditioned downstream active CATV signals 80 are divided into multiple copies and delivered from a plurality of active network ports 50, 52, 54 and 56 as shown in FIG. 2, to active subscriber equipment 6 located in subscriber network 12. In the embodiment shown in FIG. 2, subscriber equipment 6 connected to active network ports 50, 52, 54, and 56 is subscriber equipment 16 which is IHE network-compatible. It is to be understood that the example embodiments of CATV network 20, subscriber network 12, IHE network 14, and subscriber equipment 6 shown in FIG. 1 and FIG. 2 are examples only and do not limit the invention. CATV network 20 can take many different forms as is known in the art. Subscriber network 12 and IHE network 14 can take many different forms. Subscriber equipment 6 can take many different forms and combinations of equipment, as each subscriber connects different equipment in different rooms of their home or business. In some embodiment the subscriber equipment 6 connected to passive port 45 is IHE network-compatible (see FIG. 7 for example). In some embodiment all of the subscriber equipment 6 connected to active ports 50, 52, 54, and 56 are not IHE network-compatible. In some embodiments the subscriber equipment 6 connected to active ports 50, 52, 54, and 56 is a combination of some device 15 that are not IHE network-compatible and some devices 16 that are IHE network-compatible.

CATV network 20 receives upstream CATV signals 40 from CATV entry adapter 10 at entry port 44. Upstream CATV signals 40 are of a second frequency range, this second frequency range being 5-42 MHz in this embodiment. CATV subscriber equipment 6 typically generates upstream CATV signals 40 and delivers them to CATV entry adapter 10 for routing to CATV network 20. Upstream CATV signals 40 usually include upstream passive CATV signals 78 generated by passive subscriber equipment coupled to passive network port 45, and active upstream CATV signals generated by active subscriber equipment coupled to active network ports 50, 52, 54, and 56 of CATV entry adapter 10. In the disclosed embodiment of CATV entry adapter 10, however, active CATV upstream signals are not used. Instead the active subscriber equipment coupled to active ports 50, 52, 54, and 56 generate IHE signals 90 which are encoded with the upstream CATV requests that are normally sent via active upstream CATV signals. Therefore in the embodiments shown there are no upstream active CATV signals. CATV entry adapter 10 is not limited in this aspect, however. In some embodiments of CATV entry adapter 10 according to the invention entry adapter 10 includes an upstream active CATV signal transmission path for conducting active upstream CATV signals from one or all of the active network ports of entry adapter 10 to entry port 44 and CATV network 20. Such an embodiment of entry adapter 10 could be used to minimize the number of different hardware configurations of entry adapter 10, for example, so that one design of entry adapter 10 could be used for subscribers that use an IHE network and for subscribers who do not use an IHE network.

IHE signals 90 have a third frequency range, which in this embodiment is in the range of 1125-1675 MHz. IHE signals 90 include upstream and downstream IHE signals 90 which are sent back and forth within IHE network 14 between the different pieces of subscriber equipment 16 that are IHE-compatible. IHE signals 90 travel upstream from one multimedia device 16 to entry adapter 10, then from entry adapter 10 travel to another multimedia device 16.

CATV entry adapter 10 as shown in FIG. 2 includes housing 58 which encloses the internal electronic circuit components of entry adapter 10 (example embodiments shown in FIG. 3 through FIG. 9). Mounting flange 60 surrounds housing 58, and holes 62 in flange 60 allow attachment of CATV entry adapter 10 to a support structure at the subscriber premises. Electrical power for CATV entry adapter 10 is supplied from a conventional DC power supply 66 connected to dedicated power input port 68. Alternatively, electrical power can be supplied through a conventional power inserter (not shown) that is connected to one of the active ports 50, 52, 54 or 56. The power inserter allows relatively low voltage DC power to be conducted through the same active port that also conducts high-frequency signals. Use of a conventional power inserter eliminates the need for a separate dedicated power supply port 68, or provides an alternative port through which electrical power can also be applied. The power supply 66 or the power supplied from the power inserter is typically derived from a conventional wall outlet (not shown) within subscriber premises 12.

CATV network 20 is connected to CATV network entry port 44 of CATV entry adapter 10. Network ports 44, 45, 50, 52, 54, 56 and 68 are each preferably formed by a conventional female coaxial cable connector which is mechanically connected to housing 58 and which is electrically connected to internal components of CATV entry adapter 10. Coaxial cables 18 from the subscriber premises cable infrastructure and drop cables 38 (FIG. 1) are connected to CATV entry adapter 10 by mechanically connecting the corresponding mating male coaxial cable connector (not shown) on these coaxial cables to the female coaxial cable connectors forming the ports 44, 45, 50, 52, 54, 56 and 68.

Often one CATV entry adapter 10 is located at each subscriber premises. The number of active and passive network ports 45, 50, 52, 54 and 56 is dictated by the number of coaxial cables 18 which are routed throughout the subscriber premises. Although entry adapter 10 shown in FIG. 2 includes seven ports, other embodiments of entry adapters 10 have a larger or smaller number of network ports. The number and routing of the coaxial cables 18 within the subscriber premises constitutes the in-home or subscriber premise cable infrastructure that is used by subscriber premise network 12 and IHE network 14.

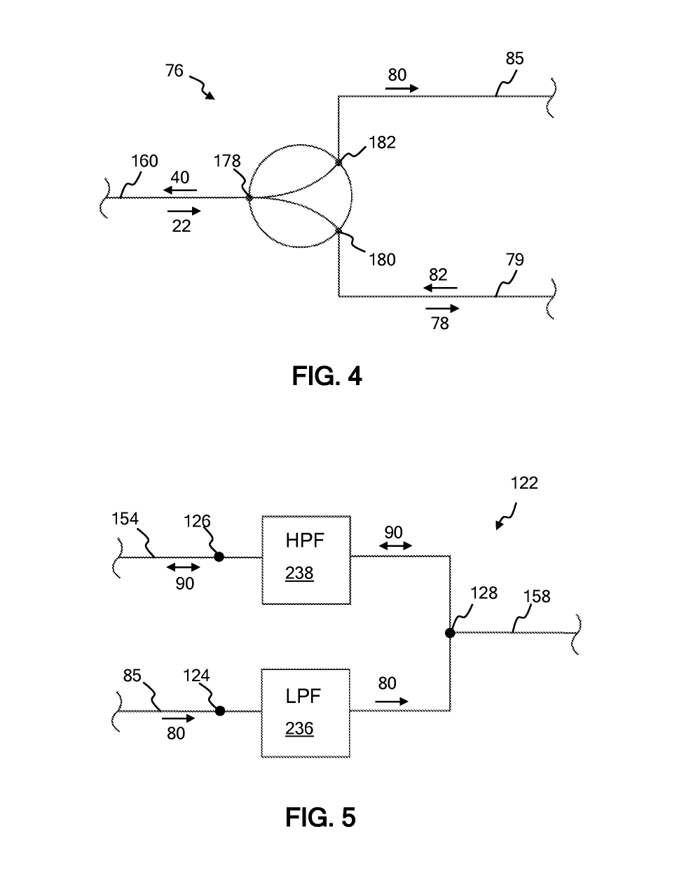

Each of the coaxial cables 18 of the in-home cable infrastructure terminates at a cable outlet 70. Those coaxial cables 18 which are not currently in use are terminated with an appropriate termination resistor (not shown) located at the cable outlet 70 of the coaxial cables 18. In most cases however, the cable outlet 70 of the coaxial cables 18 is connected to a piece of subscriber equipment 6. In the embodiments shown in FIG. 2, passive network port 45 is connected via a coaxial cable 18 to eMTA 17. In the embodiment shown in FIG. 2 and FIG. 3 eMTA 17 is not IHE signal-compatible. In the embodiment of entry adapter 10 shown in FIG. 4, eMTA 17 is IHE signal-compatible.

In the embodiments shown in FIG. 2, FIG. 3, and FIG. 7, active network ports 50, 52, 54, and 56 are each coupled to a multimedia device 16, which is IHE signal-compatible. In these embodiments multimedia devices 16 are made IHE signal-compatible by being coupled to an IHE interface device 72.

IHE interface device 72 provides the capability for a multimedia device to communicate using IHE signals. Some multimedia devices 16 contain an integrated IHE interface device 72. Other multimedia devices 16 are coupled to an external IHE interface device 72. An IHE interface device 72 is a conventional item presently available for purchase and use. Each IHE interface device 72 contains a controller which is programmed with the necessary functionality to implement the IHE communication protocol. Each IHE interface device 72 is connected between the cable outlet 70 and the multimedia device 16. When the multimedia device 16 creates output signals, those output signals are encapsulated or otherwise embodied in IHE signals 90 created by the IHE interface device 72. IHE signals 90 are communicated by one IHE interface device 72 through coaxial cables 18 of the in-home cable infrastructure, through CATV entry adapter 10, and to another IHE interface device 72. The other IHE interface device 72 extracts the original output signals that were encapsulated or otherwise embodied in IHE signals 90, and supplies the original output signals to the multimedia device 16 to which the IHE interface device 72 is attached. In this manner, IHE signals 90 which contain multimedia content from one multimedia device 16 are communicated through IHE network 14 to another multimedia device 16 for use within subscriber premise network 12. Functioning in this manner, and in terms of the conventional terminology used in the field of networks, one IHE interface device 72 and one multimedia device 16 form one node 74 of the IHE network 14. In this way IHE signals 90 are communicated between different IHE nodes 74 of IHE network 14.

CATV entry adapter 10 as shown in FIG. 2 includes LAN port 118. LAN port 118 is used to conduct LAN signals 144, that in this embodiment contain upstream CATV requests, to a cable modem for conversion to passive upstream CATV signals. In this embodiment LAN port 118 is electrically coupled to eMTA 17, as will be discussed in more detail shortly.

FIG. 3 shows a block diagram of the internal functional components of one embodiment of CATV entry adapter 10 according to the invention. CATV entry adapter 10 according to the invention includes a LAN signal transmission path, an IHE signal transmission path, and a LAN-to-RF transceiver. The LAN-to-RF transceiver electrically couples the LAN signal transmission path to the IHE signal transmission path. The LAN signal transmission path is LAN signal transmission path 152 in the embodiment of CATV entry adapter 10 of FIG. 3. LAN signal transmission path 152 conducts LAN signals between LAN port 118 and LAN-to-RF signal transceiver 150.

CATV entry adapter 10 of FIG. 3 also includes a CATV signal transmission path. The CATV signal transmission path conducts downstream CATV signals of a first frequency range and upstream CATV signals of a second frequency range from entry port 44 to passive and active network ports 45, 50, 52, 54, and 56. In this embodiment the first frequency range of downstream CATV signals is 54-1002 MHz, and the second frequency range of the upstream CATV signals is 5-42 MHz. The CATV signal transmission path includes combined passive/active CATV signal transmission path 160, passive CATV signal transmission path 79, active CATV signal transmission path 85, and combined active CATV/IHE signal transmission path 158. In this way CATV entry adapter 10 includes a CATV signal transmission path which conducts downstream CATV signals of a first frequency range and upstream CATV signals of a second frequency range between entry port 44 and at least one of a plurality of network ports 45, 50, 52, or 56.

The IHE signal transmission path of entry adapter 10 of FIG. 3 conducts IHE signals 90 of a third frequency range between LAN-to-RF transceiver 150 and one or more than one of active network ports 50, 52, 54, and 56. In this embodiment the third frequency range is the range of 1125-1675 MHz. The IHE signal transmission path of entry adapter 10 according to the invention of FIG. 3 includes IHE signal transmission path 154, and combined active CATV/IHE signal transmission path 158. In this way CATV entry adapter 10 includes an IHE signal transmission path, where the IHE signal transmission path conducts IHE signals 90 of a third frequency range between LAN-to-RF transceiver 150 and at least one of a plurality of network ports.

LAN-to-RF transceiver 150 is used to convert IHE signal to LAN signals, and vice versa. LAN-to-RF transceiver 150 is used in CATV entry adapter 10 according to the invention to convert IHE signals 90 that include encoded upstream CATV requests into LAN signals 144 with encoded upstream CATV requests. LAN signals 144 with encoded upstream CATV requests can then be sent to a cable modem and converted to passive upstream CATV signals 82, and from there sent to cable head-end 24 for processing of the upstream CATV requests. This technique and hardware for sending upstream CATV signal requests allows entry adapter 10 according to the invention to send upstream CATV requests without using an active upstream CATV signal transmission path. Not using an active upstream CATV signal transmission path to deliver upstream CATV requests to head-end 24 provides several advantages, as discussed earlier. With no active upstream CATV signal transmission path within entry adapter 10, entry adapter 10 does not deliver noisy active upstream CATV signals to CATV network 20. CATV network 20 is therefore less likely to get drowned with noise from noisy active upstream CATV signals. In addition, any subscriber multimedia equipment 16 which is a set-top box is not required to include a modem as part of its hardware. The subscriber and the supplier of the set-top box are able to use a less costly one-way set-top box for multimedia device 16.

In the embodiment shown in FIG. 3, LAN-to-RF transceiver 150 electrically couples LAN signal transmission path 152 to IHE signal transmission path 154. LAN-to-RF transceiver 150 converts IHE signals 90 to LAN signals 144 and vice versa. In this embodiments, IHE signals 90 are radio-frequency (RF) signals in the IHE signal frequency band of 1125 to 1675 MHz, but the invention is not limited in this aspect. IHE signal 90 according to the invention can be IHE signals of any type, frequency, or protocol.

In some embodiments, LAN signals 144 are Ethernet signals 144, but the invention is not limited in this aspect. LAN signals 144 according to the invention can be LAN signals of any type, frequency, or protocol.

In a specific embodiment IHE signals 90 are radio-frequency (RF) signals in the IHE signal frequency band of 1125 to 1675 MHz, LAN signals 144 are Ethernet signals 144, and LAN-to-RF transceiver 150 is an Ethernet-to-RF transceiver. In another specific embodiment, IHE signals 90 are signals which use the Multimedia-over Coax Alliance (MoCA) protocol, and so IHE signals 90 are MoCA signals 90, and LAN-to-RF transceiver 150 is an Ethernet-to-MoCA transceiver. In some embodiments IHE signals 90 are IHE signals with a frequency greater than or equal to 1125 MHz. It is to be understood that these are example embodiments and many other types of LAN and IHE signal embodiments are possible according to the invention.

CATV entry adapter 10 according to the invention of FIG. 3 includes conventional bi-directional signal splitter 76. Signal splitter 76 separates CATV downstream signals 22 that are received from CATV network 20 at entry port 44 into passive downstream CATV signals 78 and active downstream CATV signals 80. Combined passive/active CATV signal transmission path 160 conducts passive and active CATV signals 22 and 40 from entry port 44 to signal splitter 76. Combined passive/active CATV signal transmission path 160 conducts downstream CATV signals 22 from entry port 44 to splitter/combiner node 178 (see FIG. 4) of signal splitter 76. Downstream CATV signals 22 conducted from entry port 44 to splitter/combiner node 178 of signal splitter 76 include downstream active signals 80 and downstream passive signals 78. Thus combined passive/active CATV signal transmission path 160 conducts downstream active CATV signals 80 and downstream passive CATV signals 78 from entry port 44 to splitter/combiner node 178 of signal splitter 76. Combined passive/active CATV signal transmission path 160 conducts upstream CATV signals 40 from splitter/combiner node 178 of signal splitter 76 to entry port 44. In this embodiment of entry adapter 10, upstream CATV signals 40 conducted from splitter/combiner node 178 of signal splitter 76 to entry port 44 include passive upstream CATV signals 82. In some embodiments of entry adapter 10, upstream CATV signals 40 conducted from splitter/combiner node 178 of signal splitter 76 to entry port 44 also include active upstream CATV signals. In the embodiments of entry adapter 10 shown in the figures no active upstream CATV signals are used in order to eliminate introducing the noise from active upstream CATV signals onto CATV network 20.

A signal splitter (also referred to as a splitter/combiner or a splitter) such as splitter 76 divides a signal received at its splitter/combiner node (node 178 for splitter 76 of FIG. 4) into two signals, a first signal that is delivered to a first splitter leg node of the splitter (first splitter leg node 180 of splitter 76 of FIG. 4), and a second signal that is delivered to a second splitter leg node of the splitter (second splitter leg node 182 of splitter 76 of FIG. 4). Some splitters have more than two legs, and divide the incoming signals into more than two copies. In a splitter such as splitter 76 each signal received at a signal leg is a copy of the original signal received at the splitter/combiner node, but of a reduced power, with the power of the original signal being divided equally between the legs of the splitter. Similarly, signals travelling towards the first and second splitter leg nodes of the splitter are combined into a single signal at the splitter/combiner node of the signal splitter.

A schematic diagram of splitter 76 of the embodiment of entry adapter 10 of FIG. 3 is shown in FIG. 4. Combined passive/active CATV signal transmission path 160 electrically couples entry port 44 to splitter/combiner node 178 of splitter 76. Combined passive/active CATV signal transmission path 160 conducts passive and active CATV downstream signals 22 and passive CATV upstream signals 40 between entry port 44 and splitter/combiner node 178 of splitter 76. In the embodiment of entry adapter 10 according to the invention shown in FIG. 3, combined passive/active CATV signal transmission path 160 also includes IHE filter 51. IHE filter 51 is a low-pass filter which passes CATV upstream and downstream signals of the first and second frequency ranges, and blocks IHE signals of the third frequency range. IHE filter 51 is used to ensure that IHE signals 90 do not leave subscriber premise network 12 and enter CATV network 20. In some embodiments IHE filter 51 is not used, or is located in a position other than inside of CATV entry adapter 10.

Signal splitter 76 divides combined passive/active CATV signal transmission path 160 into passive CATV signal transmission path 79 and active CATV signal transmission path 85. Passive CATV signal transmission path 79 conducts passive CATV signals 78 and 82 between first splitter leg node 180 of signal splitter 76 and passive network port 45. Active CATV signal transmission path 85 conducts active CATV signals 80 between second splitter leg node 182 of signal splitter 76 and low frequency node 124 of diplexer 122 (see FIG. 5 of diplexer 122, to be discussed further shortly).

Passive CATV signal transmission path 79 conducts passive CATV signals 78 and 82 between first splitter leg node 180 of signal splitter 76 and passive network port 45. Passive CATV signals conducted by passive CATV signal transmission path 79 include passive upstream CATV signals 82 and passive downstream CATV signals 78. Passive downstream CATV signals 78 are conducted to and through passive port 45 to the passive subscriber equipment that is connected to passive network port 45, which in this embodiment is eMTA 17, which includes modem 46 and VOIP adapter 43. Passive upstream CATV signals 82 are created by eMTA 17 and are conducted through passive port 45. Passive CATV signal transmission path 79 conducts passive upstream CATV signals 82 to signal splitter 76. Passive upstream CATV signals 82 enter splitter 76 at first splitter leg node 180 and exit splitter 76 at splitter/combiner node 178 as upstream CATV signals 40, which are conducted to CATV network 20 by combined passive/active CATV signal transmission path 160. Passive CATV signal transmission path 79 in CATV entry adapter 10 contains no active electronic components that might fail or malfunction, thereby enhancing the reliability of CATV passive communications. Passive CATV signal transmission path 79 is intended to be as reliable as possible since it may be used in emergency and critical circumstances. In this embodiment eMTA 17 is connected to telephone set 48, which is used as a lifeline telephone that provides emergency telephone services and must be operational even when power is not available to entry adapter 10.

In entry adapter 10 according to the invention of FIG. 3, passive upstream CATV signals 82 may include upstream CATV requests from active subscriber equipment 6 that is connected to active network ports 50, 52, 54, and 56. Upstream CATV requests from multimedia devices 16 connected to active network port 50, 52, 54, and 56 use IHE interface device 72 to encode upstream CATV requests into upstream IHE signals 90. IHE signals 90 received at active ports 50, 52, 54, and 56 are routed to LAN-to-RF transceiver 150, where they are converted into LAN signals 144. LAN signals 144 are delivered through LAN port 118 to cable modem 46 of eMTA 17. Cable modem 46 of eMTA 17 converts LAN signals 144 that are encoded with upstream CATV requests into passive upstream CATV signals 82, which are conducted to CATV network 20 via passive port 45, passive CATV signal transmission path 79, combined passive/active CATV signal transmission path 160, and entry port 44. In this way upstream CATV requests from active subscriber equipment are delivered to CATV network 20 without using an active upstream CATV signal transmission path in entry adapter 10.

Active CATV signal transmission path 85 conducts active CATV signals 80 between second splitter leg node 182 of signal splitter 76 and low frequency node 124 of diplexer 122. FIG. 5 shows one schematic embodiment of diplexer 122. A diplexer is similar to a signal splitter in that it divides signals travelling in one direction into multiple signals and combines signals traveling in the other direction along the multiple paths into a single signal. A diplexer is different from a signal splitter, however, in that it divides signals according to signal frequency. A splitter divides signals equally among all of its legs, with each split signal being a lower power copy of the original, with the power of the original divided equally among the multiple legs. A diplexer uses frequency selective filters to divide an original signal into multiple signals of different frequency ranges or bands. Diplexer 122 includes a high-frequency leg which includes high-pass filter (HPF) 238 and a low frequency leg which includes low-pass filter (LPF) 236. In this embodiment of diplexer 122, diplexer 122 divides signals into CATV signals of a first and a second frequency range, which in this embodiment have frequencies less than 1002 MHz, and IHE signals of a third frequency range, which in this embodiment have frequencies greater than 1125 MHz. LPF 236 passes CATV signals in the first and second frequency range below 1002 MHz, and rejects IHE signals 90 in the third frequency range above 1125 MHz. HPF 238 rejects CATV signals in the first and second frequency range below 1002 MHz, and passes IHE signals 90 in the third frequency range above 1125 MHz. Diplexer 122 in this embodiments couples IHE signal transmission path 154, active CATV signal transmission path 85 and combined active CATV/IHE signal transmission path 158.

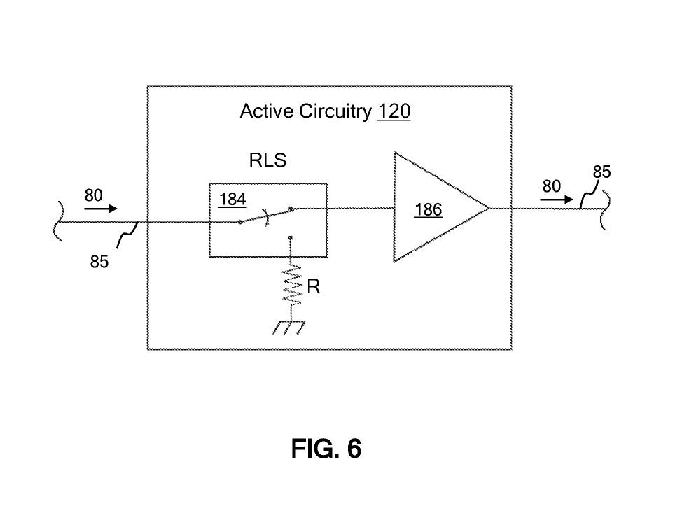

Active downstream CATV signal transmission path 85 includes active circuitry 120. Active downstream signals 80 are conducted from second output node 182 of signal splitter 76 to low frequency node 124 of diplexer 122 through active circuitry 120. Active circuitry 120 can be any form or type of active circuitry which amplifies, conditions, or otherwise operates on downstream CATV signals 80 conducted along active CATV signal transmission path 85. FIG. 6 shows one embodiment of active circuitry 120, where active circuitry 120 includes return loss saver (RLS) 184 and amplifier 186. Amplifier 186 amplifies active CATV downstream signals 80 so that CATV downstream signal 80 can be divided into multiple copies—at splitter 130 in this embodiment—without losing signal quality in each of the split signals—which are received by multimedia devices 16 coupled to active network ports 50, 52, 54, and 56. RLS 184 includes a switch that switches to a standard termination impedance R if power is lost to active circuitry 120, or other damage to active circuitry 120 is detected. RLS 184 protects passive CATV signal path 79 and the rest of the circuitry in entry adapter 10 from harmful signal reflections or noise if active circuitry 120 is damaged or unpowered. It is to be understood that active circuitry 120 according to the invention can include many other different forms, types and embodiments of active circuitry for conditioning active downstream CATV signals 80.

In the embodiments of entry adapter 10 shown in FIG. 3, there are no upstream active CATV signals being created or conducted because we are avoiding using active upstream CATV signals in this embodiment of CATV entry adapter 10. Entry adapter 10 according to the invention is not limited in this aspect, however. In some embodiments of CATV entry adapter 10, an active upstream CATV signal transmission path is added in parallel to active downstream CATV signal transmission path 85 for conducting active upstream CATV signals within the entry adapter. In these embodiments diplexer 122 could be a triplexer, dividing combined CATV/IHE signal transmission path 158 into three separate signal transmission paths, an IHE signal transmission path conducting IHE signals with frequencies above 1125 MHz, an active downstream CATV signal transmission path conducting active CATV signals with frequencies of 54-1002 MHz, and an active upstream CATV signal transmission path conducting active upstream CATV signals with frequencies of 5-42 MHz. While it is advantageous to not use an active upstream CATV signal transmission path within CATV entry adapter 10, having one available in those households or situations where it is desired or necessary for a particular use may provide benefits of equipment standardization, for example. It is to be understood that these are only examples of embodiments of CATV entry adapter 10 according to the invention, many other specific signal transmission paths, routes, and component coupling in CATV entry adapter 10 according to the invention are possible.

Referring again to FIG. 3, active downstream signals 80 are conducted along active downstream CATV signal transmission path 85 from active circuitry 120 to diplexer 122 low frequency node 124, through low-pass filter 236, and through diplexer 122 splitter/combiner node 128 to combined active CATV/IHE signal transmission path 158. Low-pass filter 236 passes active downstream CATV signals 80 from low-frequency node 124 to splitter/combiner node 128 of diplexer 122, but does not allow IHE signals 90 which are present at splitter/combiner node 128 to pass through LPF 236 onto active CATV signal transmission path 85.

Combined active CATV/IHE signal transmission path 158 conducts active downstream signals 80 from diplexer 122 splitter/combiner node 128 through one of the active network ports 50, 52, 54, or 56 to active multimedia devices 16. In the embodiment shown combined active CATV/IHE signal transmission path 158 includes splitter 130, but the invention is not limited in this aspect. In the embodiment shown splitter 130 couples combined active CATV/IHE signal transmission path 158 to a plurality of active network ports 50, 52, 54, and 56. Splitter 130 in this embodiment splits active CATV downstream signals 80 into multiple copies for delivery to active network ports 50, 52, 54, and 56. In some embodiments combined active CATV/IHE signal transmission path 158 does not include splitter 130, and active downstream CATV signals 80 are delivered to one active network port. In some embodiments combined active CATV/IHE signal transmission path 158 includes more than one signal splitter, and active downstream CATV signals 80 are delivered to more than four active network ports. In some embodiments combined active CATV/IHE signal transmission path 158 is divided into some number of paths other than four, delivering active downstream CATV signals 80 to a number of active network ports other than four. Combined active CATV/IHE signal transmission path 158 according to the invention conducts active downstream CATV signals 80 between splitter/combiner node 128 of diplexer 122 and one or more than one active network port 50, 52, 54, and 56.

Referring again to FIG. 3, combined active CATV/IHE signal transmission path 158 according to the invention also conducts IHE signals 90 between splitter/combiner node 128 of diplexer 122 and one or more than one active network ports 50, 52, 54, and 56. IHE signals 90 that are traveling from one IHE node 74 to another IHE node 74 enter at one active network port 50, 52, 54, or 56, jump between the signal legs of splitter 130 in the embodiment shown, and travel down another signal leg of splitter 130 through another active network port 50, 52, 54 or 56 to the destination IHE node 74.

Upstream IHE signals 90 can be IHE signals 90 which are encoded with upstream CATV requests from a multimedia device 16. Upstream IHE signals 90 travel from the source IHE node 74 through an active network port 50, 52, 54, or 56, to combined active CATV/IHE signal transmission path 158. Upstream IHE signals 90 travel along combined active CATV/IHE signal transmission path 158 from an active network port 50, 52, 54, or 56 to splitter/combiner node 128 of diplexer 122. Diplexer 122 divides combined active CATV/IHE signal transmission path 158 into active CATV signal transmission path 85 and IHE signal transmission path 154 using high-pass filter (HPF) 238 and low-pass filter (LPF) 236 as discussed earlier in regard to FIG. 5. HPF 238 as shown in FIG. 5 passes IHE signals 90 having frequencies above 1125 MHz and rejects CATV signals 80 that have frequencies below 1002 MHz. LPF 236 passes CATV signals 80 with frequencies below 1002 MHz, and rejects IHE signals 90 with frequencies above 1125 MHz. Thus diplexer 122 conducts IHE signals 90 received at splitter/combiner node 128 through HPF 238 to high-frequency splitter leg node 126 of diplexer 122.

In the embodiment of CATV entry adapter 10 shown in FIG. 3, IHE signal transmission path 154 conducts IHE signals 90 between high-frequency node 126 of diplexer 122 and RF signal node 148 of LAN-to-RF transceiver. Upstream CATV requests that are encoded onto IHE signals 90 travel along combined active CATV/IHE signal transmission path 158 from one or more than one active network port 50, 52, 54, or 56 through diplexer 122, and along IHE signal transmission path 154 to RF port 148 of LAN-to-RF transceiver 150. IHE signals 90 travel in both directions between LAN-to-RF transceiver 150 and one or more than one active network port 50, 52, 54, or 56 using IHE signal transmission path 154 and combined active CATV/IHE signal transmission path 158. In this way CATV entry adapter 10 includes IHE signal transmission path 154 and 158, where IHE signal transmission path 154 and 158 conduct signals between LAN-to-RF transceiver 150 and at least one of a plurality of active network ports 50, 52, 54, or 56.

LAN-to-RF transceiver 150 converts IHE signals 90 encoded with upstream CATV requests to LAN signals 144 encoded with upstream CATV requests. LAN signals 144 encoded with upstream CATV requests exit LAN-to-RF transceiver 150 at LAN port 146, and are conducted along LAN signal transmission path 152 to LAN port 118. LAN signal transmission path 152 conducts LAN signals 144 between LAN port 118 and LAN-to-RF transceiver 150. LAN signals 144 encoded with upstream CATV requests exit CATV entry adapter 10 at LAN port 118 onto LAN cable 145.

In a particular embodiment LAN-to-RF transceiver 150 is Ethernet-to-RF transceiver 150, LAN port 118 is Ethernet port 118, and LAN cable 145 is Ethernet cable 145. In this embodiment the LAN protocol used is an Ethernet protocol. It is to be understood that LAN signals 144 can implement any LAN protocol, and LAN-to-RF transceiver 150 can convert IHE signals 90 to any LAN protocol. The resulting LAN signals 144 may have upstream CATV requests encoded onto them when they exit CATV entry adapter 10 according to the invention.

In the embodiment of entry adapter 10 according to the invention as shown in FIG. 3, LAN-to-RF transceiver 150 is converting LAN signals into RF signals of a third frequency range, the IHE signal 90 frequency range of 1125-1675 MHz, and vice versa. In some embodiments LAN-to-RF transceiver 150 is Ethernet-to-RF transceiver 150, and Ethernet-to-RF transceiver 150 is converting Ethernet signals into RF signals that are using a Multimedia-over Coax Alliance (MoCA) protocol, such that Ethernet-to-RF transceiver 150 is Ethernet-to-MoCA transceiver 150. Ethernet-to-MoCA transceiver 150 converts Ethernet signals into RF signals that are compliant with the MoCA protocol, and vice versa. It is to be understood that these are example embodiments and that LAN-to-RF transceiver 150 according to the invention can convert signals back and forth from signals using any LAN protocol and RF signals that may or may not conform to any particular RF protocol.

In the embodiment of CATV entry adapter 10 shown in FIG. 3, LAN signals 144 with upstream CATV requests encoded onto them are conducted by LAN cable 145 to eMTA 17. Cable modem 46 in eMTA 17 converts LAN signals 144 into passive upstream CATV signals 82 with a frequency range of 5-42 MHz. The upstream CATV requests are thus encoded onto passive upstream CATV signals 82, enter CATV entry adapter 10 through passive port 45, and are conducted to CATV network 20 via passive CATV signal transmission path 79, combined passive/active CATV signal transmission path 160, and entry port 44. Passive upstream CATV signals 82 encoded with upstream CATV requests become upstream CATV signals 40 and are delivered to head-end 24 for processing of the upstream CATV requests. In this way upstream CATV requests are delivered to CATV network 20 by entry adapter 10 without using active upstream CATV signals or an active upstream CATV signal transmission path.

It is to be understood that LAN signals 144 encoded with upstream CATV requests can be converted to passive upstream CATV signals 82 by a device or modem other than eMTA 17 as shown in the example embodiment of FIG. 3. LAN signals 144 encoded with CATV upstream requests can be converted to passive upstream CATV signals 82 by many different types of modem hardware, and then delivered to passive port 45 for delivery to CATV network 20 by entry adapter 10.

It has been shown how the embodiment of CATV entry adapter 10 according to the invention of FIG. 3 uses LAN-to-RF transceiver 150 to send upstream CATV requests from entry adapter 10 without using an active upstream CATV signal transmission path or active upstream CATV signals. CATV entry adapter 10 of FIG. 3 uses LAN-to-RF transceiver 150 to couple IHE signal transmission path 154 in entry adapter 10 to LAN signal transmission path 152. This allows multimedia devices 16 to send upstream CATV requests by encoding the upstream CATV requests onto IHE signals 90, and sending the IHE signals 90 with upstream CATV requests encoded onto them to LAN-to-RF transceiver 150 via active network ports 50, 52, 54, or 56. The IHE signals 90 encoded with upstream CATV requests are converted to LAN signals 144 by LAN-to-RF transceiver 150, and delivered to cable modem 46 in eMTA 17, where they are converted into passive upstream CATV signals 82 encoded with upstream CATV requests. Passive upstream CATV signals 82 encoded with upstream CATV requests are received by CATV entry adapter 10 at passive port 45 and routed to CATV network 20 through entry port 44. Once the upstream CATV requests enter CATV network 20 encoded onto upstream CATV signals 40, they are delivered to CATV head-end 24 for processing of the requests. In this way entry adapter 10 sends upstream CATV requests without using an active upstream CATV signal transmission path or active upstream CATV signal conditioning circuitry. Entry adapter 10 thus does not contribute noisy active upstream CATV signals to CATV network 20, and does not require the CATV subscriber to use a two-way set-top box to generate the upstream CATV requests.

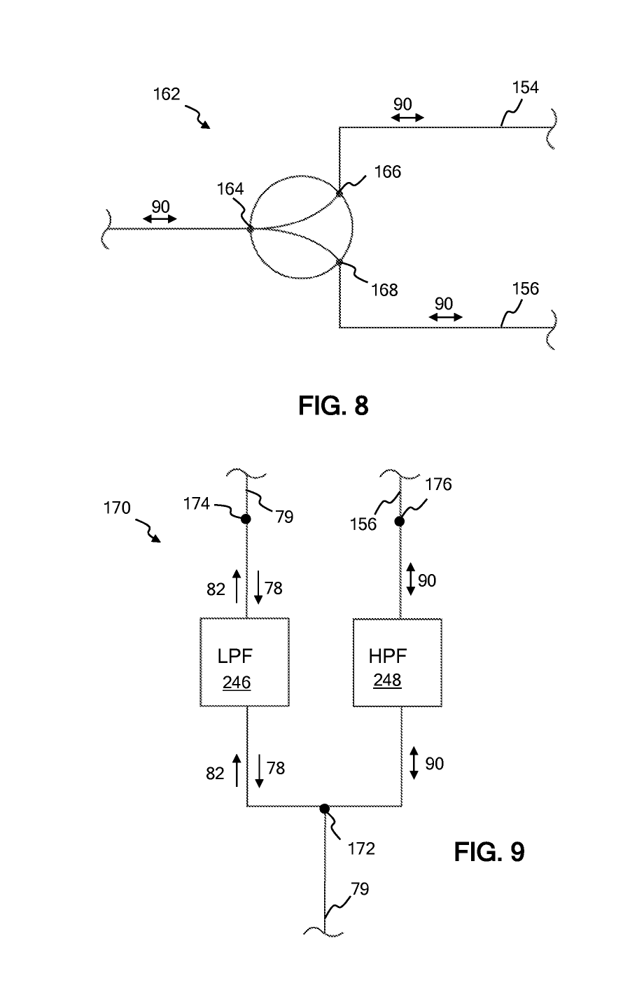

FIG. 7 shows a block diagram of an additional embodiment of CATV entry adapter 10 according to the invention, where entry adapter 10 includes splitter 162 and diplexer 170. FIG. 8 is a schematic embodiment of splitter 162 and FIG. 9 is a schematic embodiment of diplexer 170. In the embodiment of CATV entry adapter 10 according to the invention of FIG. 7, eMTA 17 is IHE signal-compatible, which is different from the system shown in FIG. 3, where eMTA is not IHE signal-compatible. In the embodiments of entry adapter 10 of FIG. 7, eMTA 17 of FIG. 3 is made IHE signal-compatible by connecting it to an IHE interface device 72. In some embodiments the IHE interface device 72 can be included in eMTA 17. In the embodiment of FIG. 7, eMTA 17 is connected to passive port 45 of CATV entry adapter 10 through IHE interface device 72. IHE interface device 72 connected to eMTA 17 enables eMTA 17 to send and receive IHE signals 90. In this embodiment of CATV entry adapter 10, the IHE signal transmission path is expanded to provide for transmission of IHE signals 90 with upstream CATV requests encoded on them to be sent to eMTA 17 through passive signal port 45. Once IHE signals 90 with upstream CATV requests encoded on them reach eMTA 17 through passive port 45, cable modem 46 in eMTA 17 converts the IHE signals 90 with upstream CATV requests encoded onto them into passive upstream CATV signals 82 with upstream CATV requests encoded on them. The passive upstream CATV signals 82 with upstream CATV requests encoded on them are delivered to CATV network 20 through entry adapter 10 as in the earlier embodiment of CATV entry adapter 10 shown in FIG. 3.

In entry adapter 10 of FIG. 7, signal splitter 162 (FIG. 8) divides the IHE signal transmission path into two IHE signal transmission paths, IHE signal transmission path first leg 154 and IHE signal transmission path second leg 156. Splitter/combiner node 164 of splitter 162 is electrically coupled to IHE port 148 of LAN-to-RF transceiver 150. IHE signal transmission path first leg 154 conducts IHE signals 90 between first splitter leg node 166 of splitter 162 and high frequency node 126 of diplexer 122. IHE signal transmission path second leg 156 conducts IHE signals 90 between second splitter leg node 168 of splitter 162 and passive network port 45, through diplexer 170 (FIG. 9).

Diplexer 170 electrically couples passive CATV signal transmission path 79 and IHE signal transmission path second leg 156 to passive network port 45. Diplexer 170 divides upstream CATV signals 82 and upstream IHE signals 90 from passive network port 45 into passive upstream CATV signals 82, which are sent to splitter 76, and upstream IHE signals 90, which are sent to splitter 162. Passive upstream CATV signals 82 and passive downstream CATV signals 78 are conducted between splitter/combiner node 172 of diplexer 170 and low frequency node 174 of diplexer 170 through low-pass filter (LPF) 246. LPF 246 passes signals having a frequency less than 1002 MHz, and rejects signal having a frequency greater than 1125 MHz. Upstream and downstream IHE signals 90 are conducted between splitter/combiner node 172 of diplexer 170 and high frequency node 176 of diplexer 170 through high-pass filter (HPF) 248. HPF 248 rejects signals having a frequency less than 1002 MHz, and passes signals having a frequency greater than 1125 MHz.

Signal splitter 162 allows IHE communication between multimedia devices 16 connected to passive network port 45 and multimedia devices 16 connected to any of active network ports 50, 52, 54, or 56. This allows upstream CATV requests encoded onto IHE signals 90 by a multimedia device 16 coupled to one of the active network ports 50, 52, 54, or 56 to send IHE signals 90 with the upstream CATV requests encoded onto them to eMTA 17 through passive network port 45. EMTA 17 can then encode the upstream CATV request onto passive upstream CATV signals 82 and send the upstream CATV requests encoded onto passive upstream CATV signals 82 to CATV network 20 through entry port 44 as explained with regard to entry adapter 10 of FIG. 3. Thus the embodiment of CATV entry adapter 10 shown in FIG. 7 provides two paths to send upstream CATV requests to CATV network 20, both of them without using an active upstream CATV signal transmission path or active upstream CATV signals.

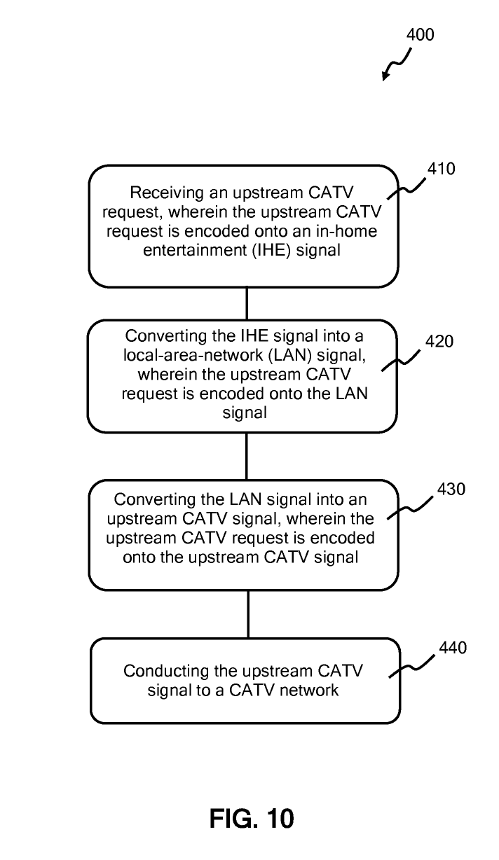

FIG. 10 illustrates method 400 of transmitting an upstream CATV request to a CATV network according to the invention. Method 400 of transmitting an upstream CATV request to a CATV network includes step 410 receiving an upstream CATV request, where the upstream CATV request is encoded onto an IHE signal, and step 420 converting the IHE signal into a LAN signal, where the upstream CATV request in encoded onto the LAN signal. Method 400 according to the invention also includes step 430 converting the LAN signal into an upstream CATV signal, where the upstream CATV request in encoded onto the upstream CATV signal. Method 400 according to the invention also includes step 440 conducting the upstream CATV signal to a CATV network.

Method 400 according to the invention can include many other steps. In some embodiments method 400 includes the step of conducting the LAN signal to a cable modem, where the cable modem is comprised in an embedded multimedia terminal adapter coupled to the passive port of an entry adapter.

Step 410 receiving an upstream CATV request, where the upstream CATV request is encoded onto an IHE signal, can include many other steps. Step 410 can include any steps involved in receiving an upstream CATV request that is encoded onto an IHE signal. In some embodiments the IHE signal is an IHE signal with a frequency range of 1125-1675 MHz. In some embodiments the IHE signal is a MoCA signal. In some embodiments step 410 receiving an upstream CATV request encoded in an IHE signal comprises the step of combining a plurality of IHE signals from a plurality of active network ports of an entry adapter into an IHE signal, where the upstream CATV request is encoded onto the IHE signal. In some embodiments step 410 receiving an upstream CATV request encoded in an IHE signal comprises the step of receiving the IHE signal encoded with the upstream CATV request at an IHE signal port of a LAN-to-RF transceiver, where the entry adapter comprises the LAN-to-RF transceiver. In some embodiments the LAN-to-RF transceiver is an Ethernet-to-RF transceiver. In some embodiments the LAN-to-RF transceiver is an Ethernet-to-MoCA transceiver.

Step 420 converting the IHE signal into a LAN signal, where the upstream CATV request in encoded onto the LAN signal, can include many other steps. Step 420 can include any step involved in converting the IHE signal into a LAN signal. In some embodiments step 420 converting the IHE signal into a LAN signal comprises converting the IHE signal into a LAN signal using a LAN-to-RF transceiver, where the upstream CATV request is encoded onto the LAN signal. In some embodiments the LAN-to-RF transceiver is an Ethernet-to-RF transceiver. In some embodiments the LAN-to-RF transceiver is an Ethernet-to-MoCA transceiver.

Step 430 converting the LAN signal into an upstream CATV signal, where the upstream CATV request is encoded onto the upstream CATV signal, can include many other steps. Step 430 can include any step involved in converting the LAN signal into an upstream CATV signal. In some embodiments step 430 converting the LAN signals into an upstream CATV signal is performed by an embedded multimedia terminal adapter coupled to a passive port of an entry adapter. In some embodiments the LAN signal is converted into an upstream CATV signal with a frequency range in the range of 5-42 MHz.

Step 440 conducting the upstream CATV signal to a CATV network can include many other steps. Step 440 can include any steps involved in conducting the upstream CATV signal to a CATV network. In some embodiments step 440 includes the step of conducting the upstream CATV signal to a passive port of an entry adapter. In some embodiments step 440 includes the step of conducting the upstream CATV signal from the passive port of the entry adapter to an entry port of the entry adapter. In some embodiments step 440 includes the step of conducting the upstream CATV signal through the entry port of the entry adapter to the CATV network, where the upstream CATV request is encoded onto the upstream CATV signal.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above

1. A cable television (CATV) entry adapter comprising:
a local-area-network (LAN) signal transmission path;
an in-home entertainment (IHE) signal transmission path; and
a LAN-to-radio-frequency (RF) transceiver, wherein the LAN-to-RF transceiver electrically couples the LAN signal transmission path to the IHE signal transmission path.

2. The entry adapter of claim 1, wherein the LAN-to-RF transceiver is an Ethernet-to-RF transceiver.

3. The entry adapter of claim 1, wherein the LAN-to-RF transceiver converts an IHE signal having a frequency greater than or equal to 1125 megahertz into a LAN signal.

4. The entry adapter of claim 1, wherein the IHE signal transmission path conducts IHE signals between an active network port of the CATV entry adapter and the LAN-to-RF transceiver.

5. The entry adapter of claim 1, wherein the IHE signal transmission path conducts IHE signals between the LAN-to-RF transceiver and a passive network port of the CATV entry adapter.

6. A cable television (CATV) entry adapter comprising:
a CATV signal transmission path, wherein the CATV signal transmission path conducts downstream CATV signals of a first frequency range and upstream CATV signals of a second frequency range between an entry port and at least one of a plurality of network ports;
a local-area-network (LAN) signal transmission path, wherein the LAN signal transmission path conducts signals between a LAN port and a LAN-to-radio-frequency (RF) transceiver;
and
an in-home entertainment (IHE) signal transmission path, wherein the IHE signal transmission path conducts IHE signals of a third frequency range between the LAN-to-RF transceiver and at least one of the plurality of network ports.

7. The adapter of claim 6, wherein the CATV signal transmission path comprises:
a combined passive/active CATV signal transmission path, wherein the combined passive/active CATV signal transmission path conducts passive CATV signals and active CATV signals between the entry port and a splitter/combiner node of a first signal splitter;
a passive CATV signal transmission path, wherein the passive CATV signal transmission path conducts passive CATV signals between a first splitter leg node of the first signal splitter and a passive network port;
an active CATV signal transmission path, wherein the active CATV signal transmission path conducts active CATV signals between a second splitter leg node of the first signal splitter and a low frequency node of a first diplexer;
and
a combined active CATV/IHE signal transmission path, wherein the combined active CATV/IHE signal transmission path conducts active CATV signals and IHE signals between a splitter/combiner node of the first diplexer and one or more than one active network port.

8. The adapter of claim 7, wherein the IHE signal transmission path conducts signals between an RF signal node of the LAN-to-RF transceiver and a high-frequency node of the first diplexer.

9. The adapter of claim 7, further comprising a second signal splitter, wherein the second signal splitter couples the combined active CATV/IHE signal transmission path to a plurality of active network ports.

10. The adapter of claim 7, wherein the IHE signal transmission path comprises a third signal splitter, wherein a splitter/combiner node of the third signal splitter is coupled to an IHE signal node of the LAN-to-RF transceiver; and wherein the third signal splitter divides the IHE signal transmission path into an IHE signal transmission path first leg and an IHE signal transmission path second leg.

11. The adapter of claim 10, wherein the IHE signal transmission path first leg conducts signals between a first splitter leg node of the third signal splitter and the high frequency node of the first diplexer.

12. The adapter of claim 10, further comprising a second diplexer, wherein the second diplexer electrically couples both the passive CATV signal transmission path and the IHE signal transmission path second leg to the passive network port.

13. The adapter of claim 10, wherein the IHE signal transmission path second leg conducts signals between a second splitter leg node of the third signal splitter and the passive network port.

14. A method of conducting an upstream cable television (CATV) request to a CATV network comprising:
receiving an upstream CATV request, wherein the upstream CATV request is encoded onto an in-home entertainment (IHE) signal;
converting the IHE signal into a local-area-network (LAN) signal, wherein the upstream CATV request is encoded onto the LAN signal;
converting the LAN signal into an upstream CATV signal, wherein the upstream CATV request is encoded onto the upstream CATV signal;
and
conducting the upstream CATV signal to a CATV network.

15. The method of claim 14, wherein receiving an upstream CATV request encoded onto an IHE signal comprises the step of combining a plurality of IHE signals from a plurality of active network ports of an entry adapter into an IHE signal, wherein the upstream CATV request is encoded onto the IHE signal.

16. The method of claim 14, wherein receiving an upstream CATV request encoded onto an IHE signal comprises the steps of:
combining a plurality of IHE signals from a plurality of active network ports of an entry adapter into an IHE signal, wherein the upstream CATV request is encoded onto the IHE signal;
and
receiving the IHE signal encoded with the upstream CATV request at an IHE signal node of a LAN-to-RF transceiver, wherein the entry adapter comprises the LAN-to-RF transceiver.

17. The method of claim 14, wherein converting the IHE signal into a LAN signal comprises converting the IHE signal into a LAN signal using a LAN-to-RF transceiver, wherein the upstream CATV request is encoded onto the LAN signal.

18. The method of claim 14, further comprising the step of conducting the LAN signal to a cable modem, wherein the cable modem is comprised in an embedded multimedia terminal adapter coupled to a passive port of an entry adapter.

19. The method of claim 14, wherein the step of converting the LAN signals into an upstream CATV signal is performed by an embedded multimedia terminal adapter coupled to a passive port of an entry adapter.

20. The method of claim 14 wherein the step of conducting the upstream CATV signal to a CATV network comprises the steps of:
conducting the upstream CATV signal to a passive port of an entry adapter;
conducting the upstream CATV signal from the passive port of the entry adapter to an entry port of the entry adapter;
and
conducting the upstream CATV signal through the entry port of the entry adapter to the CATV network, wherein the upstream CATV request is encoded onto the upstream CATV signal.
